(19) United States
(12) Patent Application Publication
(10) Pub. No.: US 2026/0201269 A1
(43) Pub. Date: Jul. 16, 2026

(54) SYSTEM AND PROCESS FOR REMOVAL OF TOXIC CHEMICALS FROM VEGETABLE OILS

(71) Applicant: Vulcan Photonics Sdn. Bhd., Kuala Lumpur (MY)

(72) Inventors: Khong Nee KOO, Ayer Itam (MY); Mei Qun SEAH, Subang Jaya (MY); Farah Hidayah Binti JAMALUDIN, Johor Bahru (MY)

(21) Appl. No.: 19/134,201

(22) PCT Filed: Dec. 2, 2022
(86) PCT No.: PCT/MY2022/050126

§ 371 Date: May 29, 2025

(51) Int. Cl. C11B 3/10; B01D 15/20; B01J 20/10; B01J 20/12; B01J 20/18; B01J 20/20

(52) U.S. Cl. CPC C11B 3/10; B01D 15/203; B01J 20/103; B01J 20/12; B01J 20/186; B01J 20/20

(57) ABSTRACT

A system for removing toxic chemicals from a refined, bleached and deodorized oil (RBDPO) comprising: a treatment section comprising an adsorbent for removal of the toxic chemicals from the RBDPO; a regeneration section for separating the treated RBDPO from the adsorbent hence regenerating the adsorbent; wherein the adsorbent includes a material that is functionalized with a silane coupling agent such that when the toxic chemicals from the RBDPO are in contact with the functionalized adsorbent, a chemical bonding is formed between the toxic chemicals and adsorbent therefore enabling the separation of the toxic chemicals from the RBDPO and subsequently removal of the toxic chemicals from the RBDPO. A process is also disclosed herein.

### FIELD OF INVENTION

The present invention generally relates to oil processing, and more particularly a process and system for removal of toxic chemicals in vegetable oils.

### BACKGROUND

3-monochloropropane-1,2-diol (3-MCPD) and glycidyl esters (GE) are two known nephrotoxic chemicals which are typically formed when vegetable oils are heated at high temperature, such as during deep-frying using vegetable oil and during oil refinery process. Further, there are indications that higher temperatures and longer treatments during oil refining process may contribute to increasing concentrations of these chemicals in refined oil. According to Food and Drugs Administration (FDA), uptake of 3-MCPD and GE by rodents will cause severe kidney cancer which is irreversible. To date, the mitigation of 3-MCPD in vegetable oil processing plant mostly requires the change in the refinery facilities, not only the unit operators as well as refinery conditions (temperature and pressure) and processing steps resulting to additional cost.

Alternative ways have been considered to reduce the formation of these undesired chemicals especially in oil refinery processes, since there have been reports to indicate that changing or modifying oil deodorization process or systems may have an impact on the resulting overall quality of the oil in addition to generating additional wastes.

Accordingly, the reduction of these toxic chemicals remains a challenge for oil manufacturers.

### SUMMARY

In one aspect of the present invention, the present invention provides a system for removing toxic chemicals from a refined, bleached and deodorized oil (RBDPO) comprising: a treatment section comprising an adsorbent for removal of the toxic chemicals from the RBDPO; a regeneration section for separating the treated RBDPO from the adsorbent hence regenerating the adsorbent; wherein the adsorbent includes a material that is functionalized with a silane coupling agent such that when the toxic chemicals from the RBDPO are in contact with the adsorbent, a chemical bonding is formed between the toxic chemicals and the adsorbent therefore enabling the separation of the toxic chemicals from the RBDPO and subsequently removal of the toxic chemicals from the RBDPO.

In an embodiment, the functionalized material is either activated carbon, silica gel, zeolites, or kaolin.

In a further embodiment, the toxic chemicals include 3-monochloropropane-1,2-diol (3-MCPD) and glycidyl esters (GE).

In yet a further embodiment, the silane coupling agent is (3-aminopropyl)triethoxysilane (APTES) or [1-(2-amino-ethyl)-3-aminopropyl]trimethoxysilane (AAPTS)

In an embodiment, the adsorbent is coated on a mesh filter of the treatment section. Typically, the mesh filter includes a polydopamine intermediate.

In an embodiment, the adsorbent is oleophilic.

In another aspect, the present invention provides a process for removal of toxic chemicals from refined, bleached and deodorized oil (RBDPO) in an oil refinery system comprising: a treatment step comprising an adsorbent for removing the toxic chemicals from the RBDPO; a regeneration step for separating the treated RBDPO from the adsorbent hence regenerating the adsorbent; wherein the adsorbent includes a material functionalized with a silane coupling agent such that when the toxic chemicals from the RBDPO are in contact with the adsorbent, a chemical bonding is formed between the toxic chemicals and said adsorbent therefore enabling the removal of the toxic chemicals from the RBDPO.

In an embodiment, the treatment step includes directing the RBDPO into a filter column comprising a mesh coated with the adsorbent. Typically, the adsorbent includes either activated carbon, silica gel, zeolites, or kaolin functionalized with (3-aminopropyl)triethoxysilane (APTES) or [1-(2-amino-ethyl)-3-aminopropyl]trimethoxysilane (AAPTS).

Advantageously, the toxic chemicals include 3-monochloropropane-1,2-diol (3-MCPD) and glycidyl esters (GE).

Advantageously, the adsorbent can withstand high oil processing temperature up to 250° C.

In another embodiment, the regeneration step further includes removing the toxic chemicals from the adsorbent by way of desorption.

In a further aspect, the present provides an adsorbent for removing toxic chemicals from refined, bleached and deodorized palm oil (RBDPO) produced during an oil refinery process, comprising activated carbon, silica gel, zeolites, or kaolin functionalized with a silane coupling agent, wherein when the toxic chemicals are in contact with the adsorbent a chemical bonding is formed therefore enabling the separation of the toxic chemicals from the RBDPO and subsequently removal of the toxic chemicals from the RBDPO.

Advantageously, the toxic chemicals include 3-monochloropropane-1,2-diol (3-MCPD) and Glycidyl ester (GE).

### BRIEF DESCRIPTION OF DRAWINGS

The invention will be more understood by reference to the description below taken in conjunction with the accompanying drawings herein:

FIG. 1 provides a schematic diagram showing the adsorption of the toxic chemicals onto the functionalized mesh in accordance with an embodiment of the present invention; and

FIG. 2 shows an exemplary of the toxic chemicals removal system in accordance with an embodiment of the present invention.

### DETAILED DESCRIPTION

In line with the above summary, the following description of a number of specific and alternative embodiments is provided to understand the inventive features of the present invention. It shall be apparent to one skilled in the art, however that this invention may be practiced without such specific details. Some of the details may not be described at length so as not to obscure the invention. For ease of reference, common reference numerals will be used throughout the figures when referring to the same or similar features common to the figures.

Embodiments of the invention are described by way of illustration. As will be realized, the invention is capable of other and different embodiments and its several details are capable of modifications in various respects, all without departing from the scope of the present invention. It should be noted that the drawings include schematic description of how the process in accordance with the preferred embodiments can be carried out. The necessary pumps, valves, and other standard equipment or components may have not been illustrated since they are known in the art.

In one embodiment, the present invention provides a process for removing toxic chemicals in vegetable oils in the presence an adsorbent that is accordingly modified to be selective to toxic chemicals that are commonly produced when vegetable oil is heated at high temperature or during an oil refinery process where the refining process typically requires high temperatures to convert or transform oil into useful products. These toxic chemicals include 3-monochloropropane-1,2-diol (3-MCPD) and Glycidyl ester (GE).

More specifically, the present invention provides a process for removing toxic chemicals from a refined, bleached and deodorized oil (RBDPO) comprising: a treatment step comprising an adsorbent for removing the toxic chemicals from the RBDPO; and a regeneration step for separating the treated RBDPO from the adsorbent hence regenerating the adsorbent. In this embodiment, the adsorbent includes a material functionalized with a silane coupling agent such that when the toxic chemicals from the RBDPO are in contact with the functionalized adsorbent, a chemical bonding is formed between the toxic chemicals and said coupling agent therefore separating the chemicals from the RBDPO and subsequently enabling the removal of the toxic chemicals from the RBDPO.

The adsorbent includes modified materials with responsive surface chemistry which is highly selective to 3-monochloropropane-1,2-diol (3-MCPD) and Glycidyl ester (GE). In an embodiment, the adsorbent includes either activated carbon, silica gel, zeolites, or kaolin, having a surface functionalized with a silane coupling agent to form an adsorptive network therefore creating a bonding surface for the toxic chemicals. An example of the silane coupling agent is (3-aminopropyl)triethoxysilane (APTES) or [1-(2-amino-ethyl)-3-aminopropyl]trimethoxysilane (AAPTS).

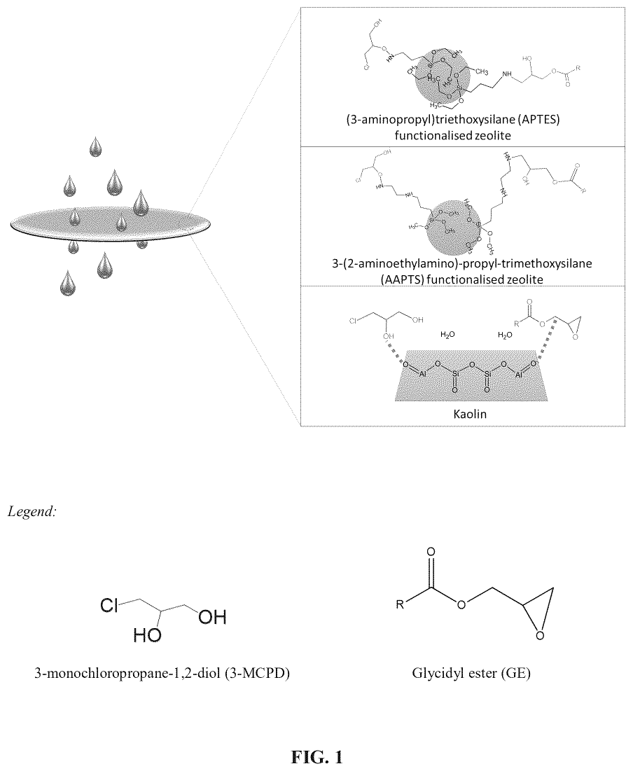

The functionalized surface forms a chemical bonding with 3-MCPD and GE once in contact with the RBDPO containing said chemicals as shown in FIG. 1. The chemical bonding therefore enables the separation of these chemicals from the RBDPO and subsequently removal of the chemicals from the RBDPO.

The present invention further provides a system for removing toxic chemicals in vegetable oils comprising: an oil refining section for producing a refined, bleached and deodorized oil (RBDPO); a treatment section for removal of the toxic chemicals from the RBDPO; a regeneration section for separating the treated RBDPO from the adsorbent hence regenerating the adsorbent.

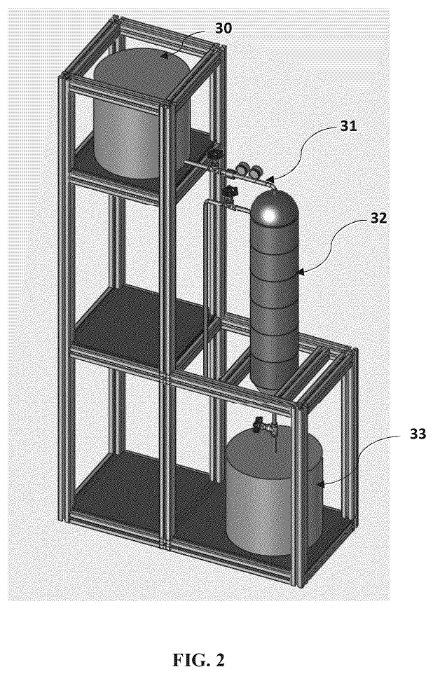

An example of the treatment section in accordance with an embodiment of the present invention is shown in FIG. 2. The RBDPO may be contained in a holding tank (30) in which an inlet (31) feeds the RBDPO stream into an adsorption column (32) comprising a filter mesh coated or provided with a layer of the functionalized adsorbent. The RBDPO feed stream flows in perpendicular to said mesh and therefore through the functionalized mesh by gravitational force. During this process, toxic chemicals are separated from the RBDPO by way of physisorption or chemisorption due to the presence of polar functional group i.e., hydroxyl, amino or carboxyl group formed on the surface of the functionalized material of the adsorbent. As a result, the toxic chemicals are retained by the functionalized mesh and the treated RBDPO is directed to a designated collection tank (33). The adsorbent is oleophilic to allow the RBDPO to flow through the functionalized mesh with minimal resistance. The oleophilic behaviour and potential binding between toxic chemicals with the modified or functionalized material therefore allow ease of removal of the toxic chemicals which is usually complicated with conventional oil removal adsorbents or materials.

The adsorbent coated mesh is thermally stable, therefore capable of operating at any high temperature of the oil after deodorization process, i.e., up to 250° C. In an embodiment, the adsorbent may be coated on a stainless steel 304 mesh with polydopamine intermediate which eliminates the requirement for a secondary process where the adsorbent typically needs to be removed by post-adsorption process.

In the regeneration section, the adsorbent is regenerated by desorption of the chemicals and subsequently removed to produce regenerated adsorbent.

In another aspect, the present invention further provides an adsorbent for removing toxic chemicals from refined, bleached and deodorized vegetable oil (RBDPO) produced during an oil refinery process, comprising activated carbon, silica gel, zeolites, or kaolin functionalized with a silane coupling agent, wherein when the toxic chemicals are in contact with the functionalized adsorbent a chemical bonding is formed therefore enabling the separation of the toxic chemicals from the RBDPO and subsequently removal of the toxic chemicals from the RBDPO. The adsorbent may be used in different configurations, such as packed bed column or prepared in free suspension form.

The adsorbent can be easily regenerated in aqueous solutions, and can maximise oil recovery up to 99%. It is capable of removing the toxic chemicals 3-MCPD and GE regardless of its concentration in RBDPO, therefore analysis of raw materials in refinery, bleaching and deodorization process can be minimized.

While the invention has been described as required in terms of preferred embodiments and specific operating ranges and conditions, those skilled in the art will appreciate that the invention described herein is susceptible to variations and modifications other than those specifically described.

1. A system for removing toxic chemicals from a refined, bleached and deodorized oil (RBDPO) comprising:
a treatment section comprising an adsorbent for removal of the toxic chemicals from the RBDPO;
a regeneration section for separating the treated RBDPO from the adsorbent hence regenerating the adsorbent;
wherein the adsorbent includes a material that is functionalized with a silane coupling agent to create an adsorptive network therefore providing a bonding surface, such that when the toxic chemicals from the RBDPO are in contact with the functionalized adsorbent, a chemical bonding is formed between the toxic chemicals and said adsorbent therefore enabling the separation of the toxic chemicals from the RBDPO and subsequently removal of the toxic chemicals from the RBDPO;
wherein the adsorbent includes zeolite, silica gel or kaolin.

2. (canceled)

3. The system according to claim 1, wherein the toxic chemicals include 3-monochloropropane-1,2-diol (3-MCPD) and glycidyl esters (GE).

4. The system according to claim 1, wherein the silane coupling agent is (3-aminopropyl)triethoxysilane (APTES) or [1-(2-amino-ethyl)-3-aminopropyl]trimethoxysilane (AAPTS).

5. The system according to claim 1, wherein the adsorbent is coated on a mesh filter of the treatment section.

6. The system according to claim 5, wherein the mesh filter includes a polydopamine intermediate.

7. The system according to claim 1, wherein the adsorbent is oleophilic.

8. A process for removal of toxic chemicals from refined, bleached and deodorized oil (RBDPO) comprising:
a treatment step comprising an adsorbent for removing the toxic chemicals from the RBDPO;
a regeneration step for separating the treated RBDPO from the adsorbent hence regenerating the adsorbent;
wherein the adsorbent includes a material that is functionalized with a silane coupling agent to create an adsorptive network therefore providing a bonding surface, such that when the toxic chemicals from the RBDPO are in contact with the adsorbent, a chemical bonding is formed between the toxic chemicals and said adsorbent therefore enabling the removal of the toxic chemicals from the RBDPO.

9. The process according to claim 8, wherein the treatment step includes directing the RBDPO into a filter column comprising a mesh coated with the adsorbent.

10. The process according to claim 8, wherein the adsorbent is either, activated carbon, kaolin, zeolites or silica gel functionalized with (3-aminopropyl)triethoxysilane (APTES) or [1-(2-amino-ethyl)-3-aminopropyl]trimethoxysilane (AAPTS).

11. The process according to claim 8, wherein the toxic chemicals include 3-monochloropropane-1,2-diol (3-MCPD) and glycidyl esters (GE).

12. The process according to claim 8, wherein the regeneration step further includes removing the toxic chemicals from the adsorbent by way of desorption.

13. The process according to claim 8, wherein the adsorbent can withstand high oil processing temperature up to 250° C.

14. An adsorbent for removing toxic chemicals from refined, bleached and deodorized palm oil (RBDPO), comprising activated carbon, silica gel, zeolites, or kaolin functionalized with a silane coupling agent to create an adsorptive network therefore providing a bonding surface, wherein when the toxic chemicals are in contact with the adsorbent, a chemical bonding is formed therefore enabling separation of the toxic chemicals from the RBDPO and subsequently removal of the toxic chemicals from the RBDPO.

15. The adsorbent according to claim 14, wherein the adsorbent comprises either, silica gel, zeolites or kaolin.

16. The adsorbent according to claim 14, wherein the toxic chemicals include 3-monochloropropane-1,2-diol (3-MCPD) and Glycidyl ester (GE).

17. The adsorbent according to claim 14, wherein an adsorptive network is formed between the silane coupling agent, silica gel, zeolites, or kaolin of the adsorbent therefore creating a surface for the chemical bonding between the toxic chemicals and the adsorbent.
